(19) United States
(12) Patent Application Publication
(10) Pub. No.: US 2009/0141436 A1
(43) Pub. Date: Jun. 4, 2009

(54) TRIM ELEMENT FOR HOUSING OF COMPUTING DEVICE

(76) Inventors: Yoshimichi Matsuoka, Cupertino, CA (US); Mark Babella, Salida, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 11/948,838

(22) Filed: Nov. 30, 2007

(51) Int. Cl. G06F 1/16

(52) U.S. Cl. 361/679.09; 361/679.02

(57) ABSTRACT

A trim element is provided for a housing assembly of a computing device. The trim element may be molded and shaped to circumvent a front facade of the housing assembly to form a perimeter trim

### TECHNICAL BACKGROUND

This application pertains to a housing for a computing device. In particular, embodiments described herein provide a trim element for a housing of a computing device.

### BACKGROUND

Computing devices, particularly handheld and portable devices, have evolved to include numerous types of communication capabilities and functionality. For example, handheld devices exist that operate as cellular phones, messaging terminals, Internet devices, while including personal information management (PIM) software and photo-management applications. Additionally, Internet Protocol services exist that can transform Internet-enabled machines into telephony devices. Even stand-alone telephones that connect to traditional Public Switched Telephone Networks (PSTN) are including more software to enhance the telephone's functionality.

In enhancing communication capabilities and functionality, effort has been made to enhance and assist the user in using such devices. For example, software features exist to facilitate the ease in which the user can act on a phone number in an email message. A sequence of phone numbers can be presented to a user for selection, and upon such selection being made, a telephony application uses the phone number in making a phone call. Small form-factor computing devices, such as devices that provide cellular phone functionality, have particular use for such short-cut functionality, in order to reduce the manual involvement of the user. These devices have smaller keyboards that may be harder to operate, and/or use in mobile or dynamic environments, where the user cannot readily retrieve a desired number.

Telephony devices are just one type of communication device. There are now many types of communication types, and multi-functional devices exist to accommodate the different communication types. Examples of communication types other than telephony include email, instant message (including SMS protocol messages and Multimedia Message Service (MMS) protocol messages), and video conferencing. Many computing devices, particularly smart phones, are enabled to support communications using multiple communication mediums.

With respect any of the devices provided, marketing and branding are important elements of the design of such devices. In the case of cellular mobile computing devices, for example, devices often need to be distinguished by cellular carrier, device manufacturer and even operating system used on the device. Moreover, distinctive design elements on devices can assist in distinguishing devices by type and functionality.

### BRIEF DESCRIPTION OF THE DRAWINGS

FIG. 1A illustrates a computing device equipped with a trim element, under an embodiment of the invention.

FIG. 1B provides a frontal sectional close-up of the trim element on the front facade, as shown by A-A, under an embodiment of the invention.

FIG. 1C is a front isometric view of a device such as shown in FIG. 1A, under an embodiment of the invention.

FIG. 1D is a bottom perspective of a device such as shown in FIG. 1A, under an embodiment of the invention.

FIG. 1E is a cross-sectional view along line B-B of FIG. 1C, under an embodiment of the invention.

FIG. 1F is a cross-sectional view along lines C-C of FIG. 1C, under an embodiment of the invention.

FIG. 2 is an exploded and isometric view of a computing device, according to an embodiment of the invention.

FIG. 3 illustrates a mid-structure for use with an embodiment such as described with FIG. 2.

FIG. 4A is a frontal view of a trim section, under an embodiment of the invention.

FIG. 4B is a side view of the trim section, as shown with FIG. 4A, under an embodiment of the invention.

### DETAILED DESCRIPTION

Embodiments described herein provide for a trim element that provides a perimeter trim for a front facade of a computing device. The trim element enables the computing device to have a visual identifier or distinctiveness, and further enables the use of color or design on the trim element to provide product branding. In the case where the computing device is a cellular device, the branding may reflect a carrier of the network used by the device.

One or more embodiments provide for a computing device that includes a display assembly, a keypad, a front facade, and a trim element. A display surface of the display assembly and an arrangement of keys that form the keypad are both provided on the front facade. The front facade also includes one or more regions where a housing surface is provided to surround the display surface and the arrangement of keys. The computing device also includes a trim element that is at least partially exposed to form a perimeter trim of the front facade. The trim element is visually distinguishable from an adjoining portion of the front facade at any point on the perimeter.

According to another embodiment, a housing assembly is provided for a computing device. The housing assembly includes a front facade on which a display surface and an arrangement of keys are provided. The front facade includes one or more regions where a housing surface is provided to surround the display surface and the arrangement of keys. A trim element is at least partially exposed to form a perimeter trim of the front facade. The trim element is visually distinguishable from an adjoining portion of the front facade at any point on the perimeter.

In still another embodiment, a housing sub-assembly of a computing device includes a platform and a trim element. The trim element protrudes from a perimeter of the platform, and the platform is dimensioned so that the trim element provides a perimeter for a front facade of the computing device.

In another embodiment, a trim element is provided for a housing assembly of a computing device. The trim element may be molded and shaped to circumvent a front facade of the housing assembly to form a perimeter trim.

Among numerous benefits provided with embodiments described herein, one or more embodiments enable for a computing device to have trim design that is in accordance with branding or design specifications of, or for, a third-party. The trim design may thus be used to provide a separate branding element that can identify some party other than the device manufacturer. In the case of cellular telephony/data devices, for example, the trim element may be branded in accordance with branding designs of the cellular network carrier. As another example, with any kind of device, the trim element may identify a reseller or provider of the device, apart from the manufacturer. Still further, the trim element may simply add decor or distinctiveness to distinguish the device from other devices in its class.

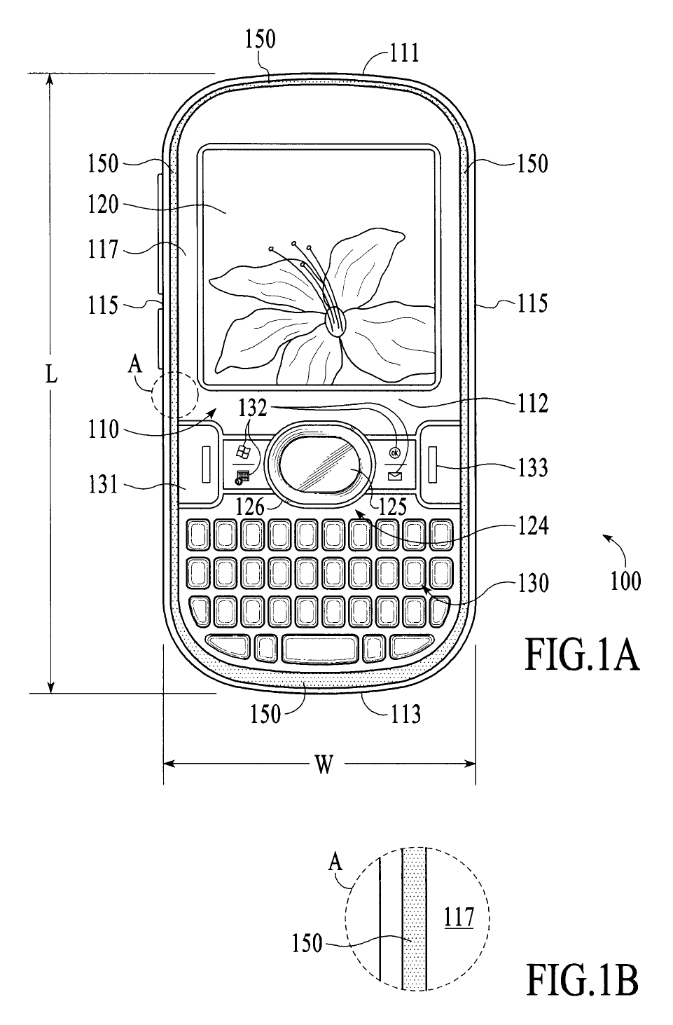

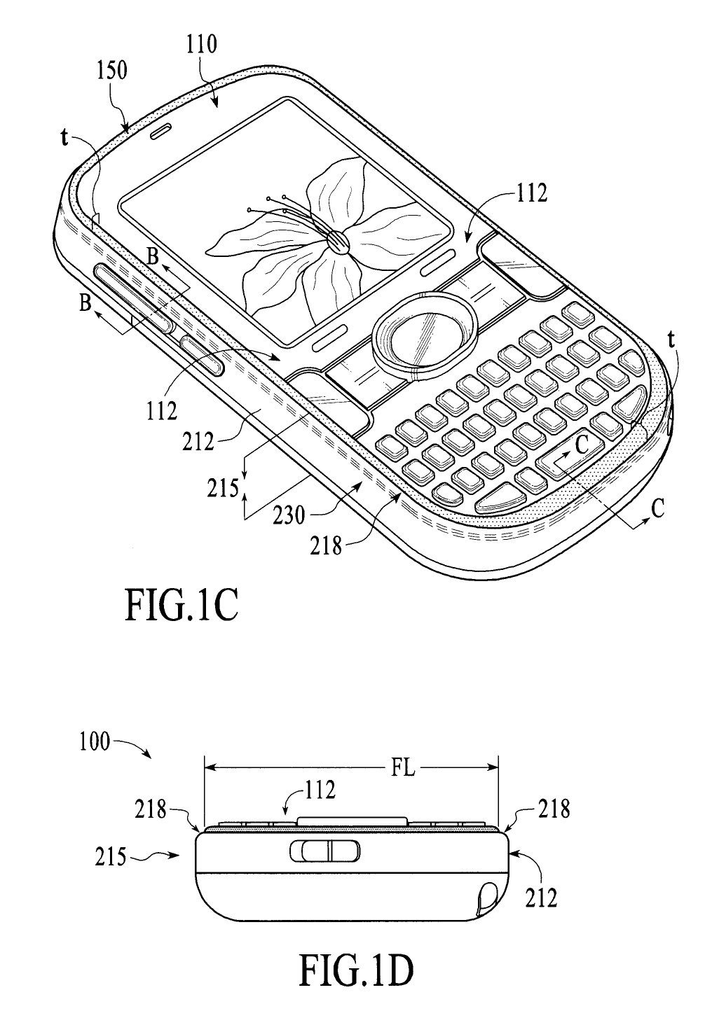

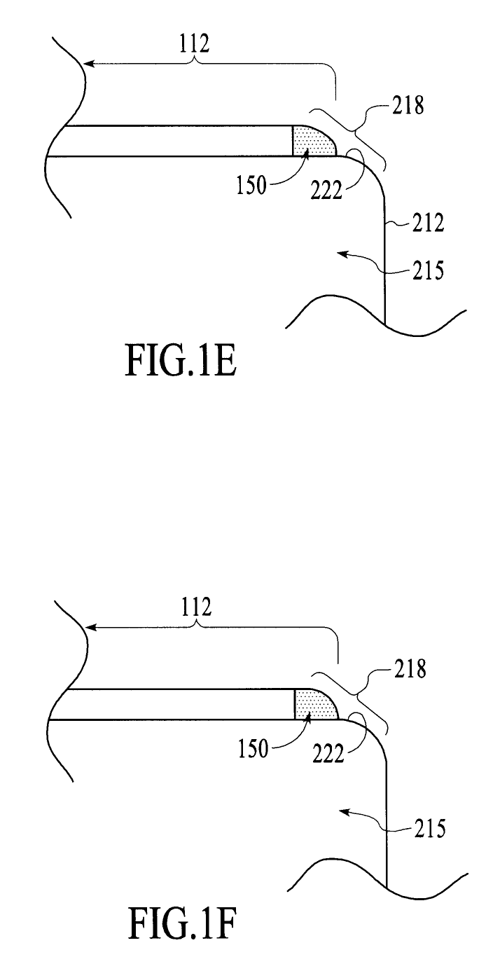

FIG. 1A illustrates a computing device equipped with a trim element, under an embodiment of the invention. The computing device shown in FIG. 1 corresponds to a cellular telephony/messaging device, although embodiments described herein may be implemented on other types of computing devices, such as media players, digital cameras and multi-functional devices. In an embodiment, the computing device 100 includes a housing 110 having a front facade 112 on which a display surface 120 and keypad 130 are provided. The front facade 112 also includes a button set 132 having a multi-state component 124. In an embodiment shown, the multi-state component 124 includes a directional element 125 and a selection button 126.

The device 100 may include a top edge 111 and a bottom edge 113, as well as a pair of lateral sides 115. A distance between the top edge 111 and the bottom edge 113 define a length L of the computing device 100. A width W of the device is defined by a span between the lateral sides 115.

A trim element 150 circumvents or forms in part a peripheral trim of the front facade 112. The peripheral trim formed by the trim element 150 may include only a surface of the trim element 150, or alternatively, be combined with one or more other peripheral surfaces to form a combination peripheral trim. In an embodiment, the trim element 150 circumvents the entire front facade 112 at or near the perimeter of the front facade 112. The trim element 150 may be colored, patterned, textured or otherwise shaped to be visually distinguishable from surrounding surfaces 117 of the front facade 112. For example, in an embodiment shown by FIG. 1, the trim element 150 is colored and the majority of the front facade 122, including the surrounding surfaces 112, are white. In this way, the trim element provides a visual contrast with the area of the front facade 112 that it surrounds.

According to an embodiment, other features provided on the front facade 112 may be color coordinated with the trim element 150. For example, the keypad 130 may be in form of a QWERTY or full-alphanumeric keyboard. In one configuration, then keys of the keypad may be delineated with color or shading to provide numeric values when the device is in numeric mode. For example, in numeric mode, the 10 keys may enable the user to dial a phone number quickly. The color or shading used to delineate the number keys from the remainder of the keys on the keypad 130 may match, or alternatively coordinate, with the shading or coloring of the trim element 150.

In an embodiment, trim element 150 is provided by a separate structure from the front facade 112 or its adjoining surfaces. Alternatively, however, the trim element 150 may be an integrated or unitarily formed extension of the surface(s) that form the front facade 112. In the latter case, for example, the front facade 112 may be molded or shaped to include the trim element 150 as an integral part of the front facade 112.

In either case, trim element 150 may be shaped. In one embodiment, the trim element 150 is raised or formed as a protrusion. In another embodiment, the trim element 150 is inset or recessed relative to the adjoining surface of the front facade 112. In an embodiment depicted, the trim element 150 is contoured to provide a transition between the front facade 112 and an adjoining side facade or surface

FIG. 1B provides a frontal sectional close-up of the trim element 150 on the front facade 112, as shown by A-A, under an embodiment of the invention. An adjoining surface 117 of the front facade 112 extends into or abuts the trim element 150. For simplicity, the trim element 150 is show as being visually distinctive from the adjoining surface 117 with shading. As mentioned elsewhere, however, the contrast or visual distinction between the adjoining surface 117 and the trim element 150 may be made with color, pattern or texture.

Moreover, one or more embodiments contemplate that front facade 112 includes variations in coloring, shading, texture or appearance amongst the various surfaces that may extend into or abut the trim element 150. Furthermore, as shown with buttons 131, 133, the adjoining surface to the trim element 150 may include the surface of a functional feature. In an embodiment, the transition from the adjoining surface to the trim element is smooth or flush, so that the transition may include a seam (particularly when the trim element 150 is provided by a separate structure). However, some or all of the surfaces on front facade 112 that surround the trim element 150 may be non-flush with the trim element 150. For example, functional features such as buttons 131, 133 may be raised with respect to a remainder of the front face 112 and/or trim element 150.

FIG. 1C is a front isometric view of the device 100, under an embodiment of the invention. The front facade 112 may transition into a peripheral surface 212 that extends around the device. The peripheral surface 212 may provide a thickness between the front facade 212 and a back facade (not visible in FIG. 1C). In an embodiment such as shown by FIG. 1C, an underlying thickness 215 of the housing 110 may also provide a portion of an overall perimeter trim for the front facade. The underlying thickness 215 may be provided with slight dimensioning of a body 230 section of the housing (as defined by the span between the peripheral surfaces 212 extending at the lateral edges 115, 115).

Under an embodiment, the trim element 150 is slightly contoured inward to provide transition from the front facade 112 to the peripheral surface 212 and body 215. For example, the trim element 150 may be arced to provide a smooth transition to the peripheral surface 212. As an alternative such as shown by FIG. 1D, the transition may be seamed. A transition edge 218 on the peripheral surface 212 may enhance or supplement the perimeter trim that is formed in part by the trim element 150. For example, in one implementation, the trim element is colored, and the transitional surface 218 is chromed in appearance, or provided the same coloring/texture as the adjoining surfaces that form portions of the front facade 112.

Additionally, as shown by an embodiment of FIG. 1C, a thickness dimension t of the trim element may vary on different regions of the front facade 112. In one embodiment, the thickness dimension t of the trim element 150 at or near the bottom edge 113 is greater than other sections of the trim element 150.

FIG. 1D is a bottom perspective of the device 100, under an embodiment of the invention. The bottom perspective is intended to be illustrative of other side-perspectives. In an embodiment such as shown by FIG. 1D, the front facade 112 is provided by the outermost planar surface, indicated by the dimension FL. The trim element 150 may form a portion of the front facade 112. As the transition to body is seamed, however, the peripheral surface 212 and resulting body 215 may form the transition surface 218, which combines with the trim element 150 to form the perimeter trim for the front facade. The transition surface 218 may provide a visual trim, in that it may appear to be part of the front facade when the device is viewed from the front perspective.

FIG. 1E and FIG. 1F each illustrate a cross-sectional view of the housing 110 with trim element 150, under an embodiment of the invention. FIG. 1E is a cross-sectional view along line B-B of FIG. 1C. FIG. 1F is a cross-sectional view along lines C-C of FIG. 1C. The trim element 150 combines with the peripheral surface 212 to form the transition surface 218 between the front façade 112 and the peripheral surface 212. An embodiment of FIG. 1E and FIG. 1F each show that a portion 222 of the body 215 may extend parallel to the front façade 112 to form a portion of the transition surface 218. However, according to an embodiment, the dimension of the body portion 222 may vary. In one implementation, the dimension of the body portion 222 may vary depending on the curvature of the trim element 150. In an implementation of FIG. 1E (which depicts the side of the housing), for example, the trim element 150 may be less arced than the implementation of FIG. 1F (which depicts the trim element on the bottom of the device).

An alternative embodiment or variation may eliminate the body portion 222 from being visible. In one embodiment, the front façade 112 includes the trim element 150, which forms the entire perimeter trim of the front façade.

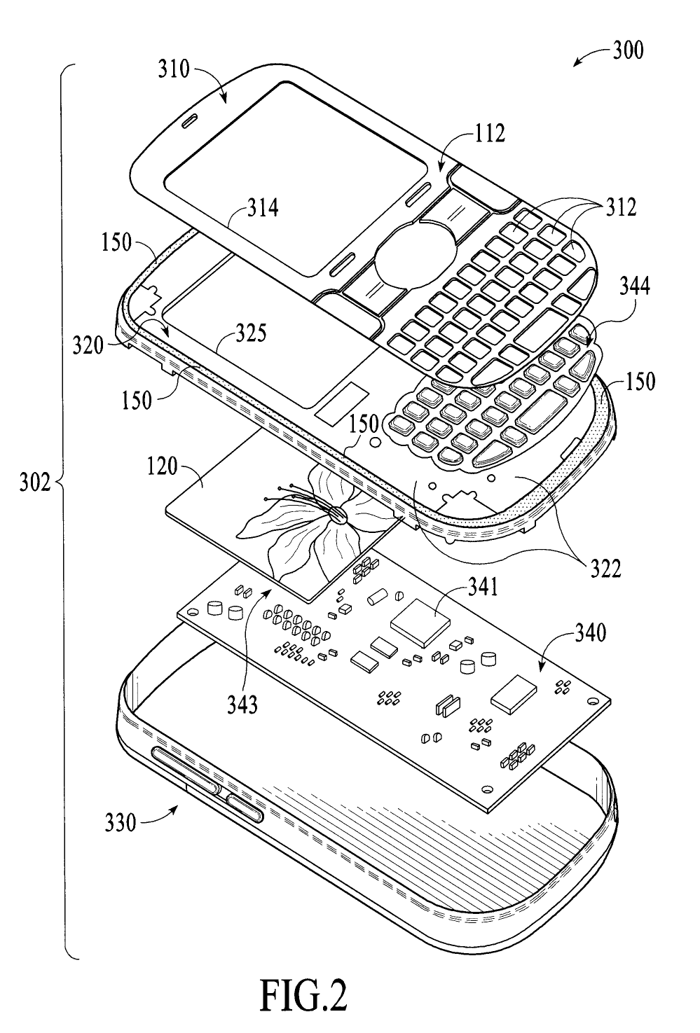

FIG. 2 is an exploded and isometric view of a computing device for use with an embodiment of the invention. A computing device 300 may include a housing assembly 302 that has structures corresponding to that of housing 110, described an embodiment of FIG. 1. Any reference to elements described elsewhere are intended to show similarity amongst depicted elements. Accordingly, computing device 300 includes the front facade 112, and the trim element 150, such as shown and described with any of the embodiments of FIG. 1A-FIG. 1D. The housing assembly 302 may be assembled from a front panel 310, a mid-structure 320, and a rear panel 330. A printed circuit board 340 may be provided within the assembled housing 302.

The front panel 310 may form and/or provide at least a substantial portion of the front facade 112. The front panel 310 may include a display surface opening 312 to receive the display surface 120, and numerous key openings 314 to receive individual keys from a keypad. Other openings or components may be provided on or with the front panel 310, such as, for example, openings or structures for a multi-way navigation component.

The printed circuit board 340 may include various components that are housed within the housing 110, including a processor 341 and a display assembly 343. The display assembly 343 may include the display surface 120 that extends into (and possibly forms a portion of) front facade 112.

In an embodiment, the mid-structure 320 provides the trim element 150 as a peripheral protrusion on that structure. The mid-structure 320 may also provide a platform 322 that supports a keypad 344. The keypad 344 may include, for example, a QWERTY arrangement or provide characters and numbers. Under one implementation, the keypad has a low profile in thickness, such as provided from sheet-key construction, where the key structures are laminated onto electrical actuators for actuating the individual key structures. Electrical connectivity between the keypad 344 and one or more components on the printed circuit board 340 (such as processor 341) may be provided through outlets, traces or other connective elements provided on the mid-structure 320. Additionally, the mid-structure 320 may include the display assembly opening 314 to accommodate the display assembly 343, so that the display surface 120 is provided with the front facade 112. As mentioned elsewhere, one or more embodiments provide that the display surface 120 forms a flush or seamless section of the front facade 112.

The rear panel 330 may provide a remainder of the containment that forms housing 110. The rear panel 330 may form at least a portion of the peripheral surface (such as provided in FIG. 1C) or peripheral body (FIG. 1C), either by itself, or in combination with one or more mid-frame structures (not shown). As an alternative or addition, the mid-structure 320 may provide a mid-frame that is sandwiched by the front panel 310 and the rear panel 330.

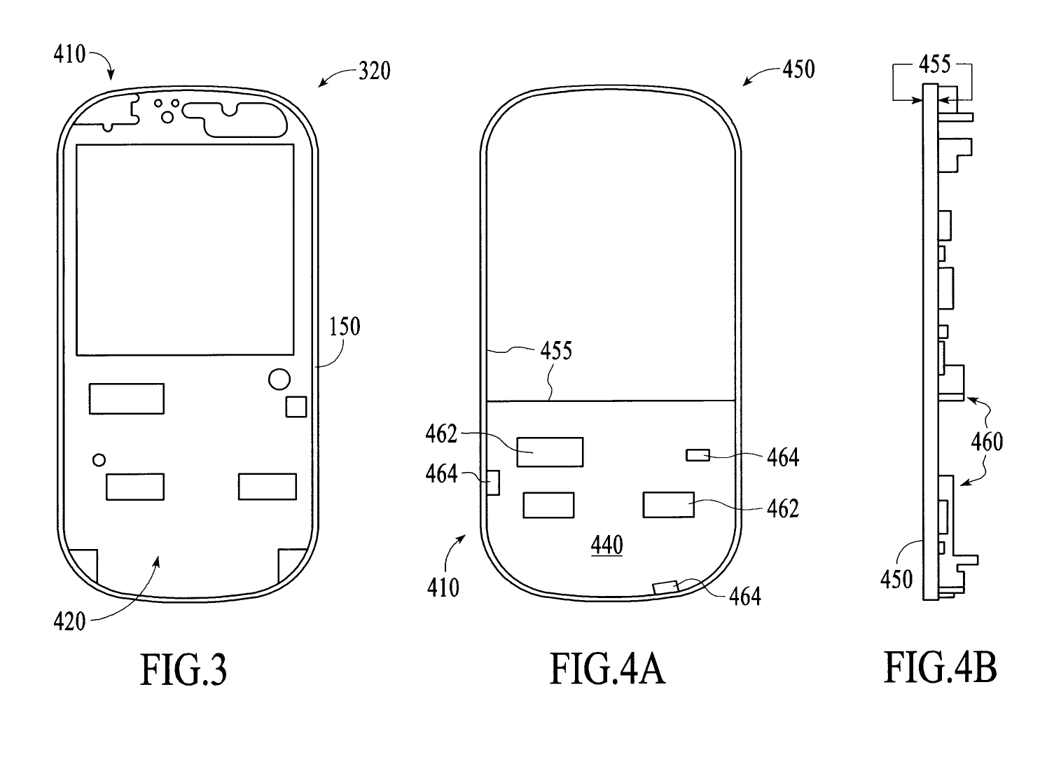

FIG. 3 illustrates the mid-structure 320 for use with an embodiment of the invention. The mid-structure 320 may correspond to that shown and described with an embodiment of FIG. 2. As such, the mid-structure 320 includes a trim section 410 and a platform piece 420. In one embodiment the trim section 410 and the platform piece 420 are separate structures. As shown by an embodiment of FIG. 4A and FIG. 4B, the trim section 410 may be shaped or molded to include the peripheral trim element 150 (FIG. 1A) as protrusions or extensions from a base segment 450. The platform piece 420 may be formed from a rigid structure that can support the keypad 344 (FIG. 2), as well as its use with the pressure applied from the user. A combination of the platform piece 420 and the trim section 410 may form the display opening 325 for the display assembly 343 (FIG. 2).

According to one embodiment, elements of the mid-structure 320 may provide a contrast in materials. The trim section 410 may be formed from molded plastic or similar material. A ‘single-shot’ molding process may be used to shape the trim section 410, so that it has protrusions dimensioned in height to form the trim element 150, as well as overall dimensions and contours to tightly circumvent, for example, the front panel 310.

FIG. 4A is a frontal view of the trim section 410, apart from the platform piece 420, under an embodiment of the invention. The trim section 410 may be molded from material such as plastic. Under an embodiment, the trim section 410 may include decor, such as color, texture, or patterning, that distinguishes at least a perimeter segment 450 that corresponds to the trim element 150 (FIG. 1). In one embodiment, the trim section 410 is translucent and colored. The trim section 410 includes a base 440 from which the perimeter segment 450 protrudes. The base 440 also supports the platform piece 420 (FIG. 4A) when the platform piece is assembled onto it. An opening 455 may provide for the display assembly 343 (FIG. 3), as described above. The opening 455 may be partially closed by the platform piece 420 to dimension for receiving the display assembly 343.

FIG. 4B is a side view of the trim section 410, as shown with FIG. 4A, under an embodiment of the invention. The perimeter segment 450 may include extensions 455, which protrude outward towards the front panel 310 (FIG. 2) when the housing is assembled. According to an embodiment, the extensions 455 may be dimensioned so that they extend to be flush, or substantially flush, with the adjoining surface 117 (FIG. 1A) provided from the front panel 310. The result is that the transition from the front panel 310 to the mid-section 320 is substantially seamless. Under one implementation, spacer structures 460 may be provided underneath the base 440 to space the mid-structure 320 from other structures which are within or form part of the housing (e.g. printed circuit board 340 (FIG. 2)).

With reference to FIG. 4B, the base 440 of the trim section 410 may include a combination of platform containment structures 462 and apertures 464. The platform containment structures 462 include structures that can be press-fitted or otherwise combined with mating apertures or receiving structures of the platform 420. The result is a low-profile connection that enables the mid-structure 320 as a whole to be thin. The apertures 464 enable the combined mid-structure 320 to be secured to a remainder of the housing assembly 310 (FIG. 2). For example, the apertures 464 may be press-fitted or mounted onto corresponding structures of another segment of the assembled housing 310.

In an embodiment of FIG. 4A and FIG. 4B, the trim section 410 may be formed to include the color, decor or design for the trim element 150, independent of the front panel 310 (FIG. 2) or any other portion of the housing. The result is that the branding, personalization or marketing aspect that can be provided with the trim element 150 may be manufactured with design of only the trim section 410. As described above, for example, the trim section 410 may be formed from a single-shot moling process to have a specified color or look.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

1. A computing device comprising:
a display assembly that includes a display surface;
a keypad assembly including an arrangement of keys;
a front facade on which the display surface and the arrangement of keys are provided, the front facade including one or more regions where a housing surface is provided to surround the display surface and the arrangement of keys; and
a trim element that is at least partially exposed to form a perimeter trim that is visibly present as part of the front facade, wherein the trim element is visually distinguishable from an adjoining portion of the front facade at any point on the perimeter.

2. The computing device of claim 1, wherein the trim element is provided as a separate structure from the housing surface.

3. The computing device of claim 1, wherein the trim element protrudes from a platform that underlies at least a majority of the front facade and spans a length and a width of the front facade.

4. The computing device of claim 3, wherein the platform includes an opening to accommodate the display assembly, and wherein the keypad assembly is provided on the platform.

5. The computing device of claim 4, further comprising a printed circuit board that interconnects the display assembly and the keypad assembly with one or more internal components of the computing device, and wherein the printed circuit board is mounted onto or over the platform.

6. The computing device of claim 1, wherein the front facade and the trim element each have a different predominant color.

7. The computing device of claim 1, wherein the trim element is visually distinguishable from an adjacent portion of the front facade as a result of a color, a shading or a texture provided on the trim element.

8. The computing device of claim 1, wherein trim element is contoured to transition the front facade into edge surfaces.

9. The computing device of claim 1, wherein the trim element is formed from a translucent and colored material.

10. A housing assembly for a computing device, the housing assembly comprising:
a front facade on which a display surface and an arrangement of keys are provided, the front facade including one or more regions where a housing surface is provided to surround the display surface and the arrangement of keys; and
a trim element that is at least partially exposed to form a perimeter trim that is visibly present as part of the front facade, and wherein the trim element is visually distinguishable from an adjoining portion of the front facade at any point on the perimeter.

11. The computing device of claim 10, wherein the front facade and the trim element each have a different predominant color.

12. The computing device of claim 10, wherein the trim element is visually distinguishable as a result of a color, a shading or a texture provided on the trim element.

13. The computing device of claim 10, wherein trim element is contoured to transition the front facade into edge surfaces.

14. The computing device of claim 10, wherein the trim element is formed from a translucent and colored material.

15. A housing sub-assembly for a computing device, the housing sub-assembly comprising:
a platform; and
a trim element that protrudes from a perimeter of the platform, wherein the platform is dimensioned so that the trim element provides a perimeter that is visibly present as part of a front facade of the computing device.

16. The housing sub-assembly of claim 15, wherein the platform is rigid to support one or more of a display assembly and keypad assembly.

17. The housing sub-assembly of claim 15, wherein the trim element is formed from a plastic material.

18. The housing sub-assembly of claim 15, wherein the trim element is unitarily formed into a base structure that forms a portion of the platform, and wherein the trim element extends from the base structure.

19. The housing sub-assembly of claim 17, wherein the trim element is translucent.

20. The housing sub-assembly of claim 17, wherein the trim element is formed molded into shape.

21. A trim element for a housing assembly of a computing device, the trim element being molded and shaped to circumvent a front facade of the housing assembly to form a perimeter trim that is a visible part of the front facade.

22. The trim element of claim 21, wherein the trim element is translucent and/or colored.

23. The trim element of claim 21, wherein the trim element circumvents a perimeter of the front facade.

24. The computing device 6, wherein the keypad includes a set of keys that provide numeric values when the computing device is operated in a numeric mode, the set of keys having a color that is distinguishable from other keys in the keypad, and wherein the color of the trim element is same as the color of the select set of keys.
